(19) United States
(12) Patent Application Publication
(10) Pub. No.: US 2011/0028194 A1
(43) Pub. Date: Feb. 3, 2011

(54) System and method for unified-context mapping of physical input device controls to application program actions

(75) Inventors: Terence Tang, Singapore (SG); Henky Jatmiko Gunawan, Singapore (SG); Min Liang Tan, Singapore (SG)

Correspondence Address: AXIS INTELLECTUAL CAPITAL PTE LTD., 21 Science Park Road, #03-01 The Aquarius Science Park II, SINGAPORE, 117628, SG

(73) Assignee: Razer (Asia-Pacific) Pte Ltd, Singapore (SG)

(21) Appl. No.: 12/462,261

(22) Filed: Jul. 31, 2009

(51) Int. Cl. A63F 9/24; G06F 3/02

(52) U.S. Cl. 463/1; 345/172

(57) ABSTRACT

Disclosed are single or unified execution context systems and processes for managing relationships between physical input device controls and application program actions in a manner that automatically accommodates firmware and/or device driver configuration operations. A process involves establishing an application program execution context; establishing a relationship (e.g., graphically) between a first physical input device control element and a first user-selectable action; and automatically maintaining the relationship between the first physical control element and the first user-selectable action such that the first user-selectable action is consistently initiated in response to user interaction with the first physical control element independent of an input device firmware or device driver reconfiguration that may change a control element signal generated by the first physical control element. Input device control element—application program action relationships can be established and/or maintained within an application program's execution context.

### TECHNICAL FIELD

The present disclosure generally relates to systems and methods for associating an input device control element with one or more application program actions. More particularly, various aspects of the present disclosure are directed to systems and methods for graphically establishing within the execution context of the application program a relationship between a physical input device control element and a set of application program actions or action sequences, and maintaining the relationship in a consistent manner across application program executions.

### BACKGROUND

Modern electronic games are typically played via a computing system such as a desktop or laptop computer. Depending upon the nature of a particular game, user interaction or game play can involve a single isolated computer system, or networked computing systems that facilitate game play amongst multiple users. An Internet-based massively multiplayer online (MMO) game can involve hundreds or even thousands of users or garners playing simultaneously. MMO games enable players to cooperate and compete with each other on a large-scale basis, typically in real time or near-real time. One example of a well-known MMO game is World of Warcraft® (Blizzard Entertainment, Irvine, Calif.).

Game-related graphical information (e.g., scenes within a particular game environment and interactions between character avatars in such scenes) and game details (e.g., character avatar status or attributes) are generally displayed upon a gamer's display screen during game play. Typically, a computer peripheral device, such as a computer mouse, a keyboard, or like input device, is used for inputting a gamer's commands or instructions into the computing system. Such instructions can include the selection of graphical elements and icons shown on the display screen in order to perform or activate a specific corresponding function or action in the game. As an example, a gamer can actuate a button on a computer mouse to select an icon (for instance, an action key that forms a portion of an action bar) displayed by the game application. Actuation of the mouse button results in the execution of a set of program instructions associated with the displayed icon, which results in the performance of a game action corresponding to the displayed icon. Such a game action can be, for instance, the activation of a skill or spell associated with a particular character avatar during game play.

In general, the actuation of a computer mouse button results in the generation of a corresponding button signal. For example, when a first mouse button is actuated, computer mouse hardware, firmware, and/or a computer mouse device driver that operates based upon a class protocol enable the generation of a corresponding first button signal.

With respect to a physical input device, a default button-to-signal relationship can be reconfigured via mouse firmware and/or the mouse device driver, such that actuation of the first mouse button results in the generation of a signal other than the first button signal. By appropriately selecting an updated firmware configuration or (re)configuring the mouse device driver, particular mouse buttons can be mapped to the generation of specific signals to facilitate the establishment of a modified or updated button-to-signal pairing. Based upon their individual knowledge and experience, a gamer can reconfigure firmware or a mouse device driver to establish a set of modified button-to-signal mappings that correspond to signals that initiate or invoke particular predefined actions, functions, or action keys within the game. A gamer may undertake such a reconfiguration, for example, to facilitate more effective or efficient game play in view of common play situations and the capabilities or attributes of a particular character avatar under the gamer's control. Such reconfiguration occurs apart or separate from game application execution.

In a game application, a default assignment of actions, functions, or action keys can be based upon a default firmware configuration or a default device driver configuration. A game application itself may apparently allow a gamer to assign or bind a game action or an action key to a mouse button. However, what actually occurs is the action or action key is assigned or bound to the button signal generated by the device driver, in contrast to being assigned or bound to the mouse button itself. Consequently, game action assignment errors and key binding mismatch can occur in response to mouse button actuation if the mouse firmware or mouse device driver has been reconfigured to output signals in accordance with a modified or updated button-to-signal mapping. As a result, the actuation of a particular mouse button can fail to produce an intended game action, or give rise to an unintended game action, adversely affecting game play.

### SUMMARY

In accordance with an aspect of the disclosure, a computer based method for managing at least one relationship between a set of physical control elements carried by an input device and a set of user-selectable actions performed by an application program in response to user input includes establishing an application program execution context; establishing a relationship between a first physical control element within the set of physical control elements and a first user-selectable action within the application program execution context; and automatically maintaining the relationship between the first physical control element and the first user-selectable action in a manner that results in the initiation of the first user-selectable action in response to user interaction with the first physical control element following a reconfiguration of one from the group of firmware corresponding to the input device and a device driver corresponding to the input device that changes a control element signal generated by the first physical control element.

According to an aspect of the disclosure, maintaining the relationship between the first physical control element and the first user-selectable action can occur within the execution context of the application program. The application program can include program instructions corresponding to one or more portions of a computer game, and in one aspect the application program corresponds to an MMO game client.

In particular aspects of the disclosure, the computer based method can further include displaying a graphical element corresponding to the input device, the graphical element providing a visual indication of at least a first physical control element within the set of physical control elements. In an aspect of the disclosure, the computer based method can further include displaying a relationship management interface that provides or includes a visual representation of the input device. An aspect of the disclosure further includes displaying an application program Graphical User Interface (GUI), wherein displaying the graphical element corresponding to the input device can occur within the application program GUI.

In accordance with an aspect of the disclosure, displaying a graphical element corresponding to the input device, establishing a relationship between the first physical control element and a first user-selectable action, and automatically maintaining a relationship between the first user-selectable action and the first physical control element are performed by the execution of program instructions defined by an add-on to the application program that provides functional capabilities beyond a base set of application program functional capabilities.

Establishing a relationship between a first physical control element and a first user-selectable action can occur in response to user input directed to a graphical element corresponding to the input device. Such user input can include a drag and drop operation involving a graphical representation of the first user-selectable action (e.g., an icon corresponding to the first user-selectable action).

Displaying a graphical element corresponding to an input device can include displaying a graphical interface that indicates for the first physical control element a physical position of the first physical control element relative to one from the group of a second physical control element within the set of physical control elements and an input device housing. Displaying a graphical element corresponding to the input device can further include displaying an input device action bar that includes a set of input device action buttons.

An aspect of the disclosure provides for an input device having a physical control element spatial organization that corresponds to a physical control element configuration carried by one from the group of a mobile telephone and a personal audio device. An aspect of the disclosure provides for the display of an input device action bar that includes an input device action button spatial organization corresponding to a physical control element configuration carried by one from the group of a mobile telephone and a personal audio device.

According to an aspect of the disclosure, establishing a relationship between the first physical control element and the first user-selectable action includes storing binding information that defines an association between an initial control element signal generated in response to user interaction with the first physical control element and the first user-selectable action. Additionally, automatically maintaining the relationship between the first physical control element and the first user-selectable action includes updating binding information to indicate an association between the first user-selectable action and an updated control element signal generated in response to user interaction with the first physical control element.

In accordance with an aspect of the disclosure, a computer based method for managing at least one relationship between a set of physical control elements carried by an input device and a set of user-selectable actions performed by an application program in response to user input includes establishing an application program execution context; retrieving first relationship information that indicates a first application program action that is intended to be initiated in response to user interaction with the first physical control element within the set of physical control elements; retrieving configuration information that indicates a mapping between the first physical control element and a control element signal that is generated in response to user interaction with the first physical control element; retrieving first binding information that indicates an association between the first application program action and a control element signal that can be generated by a physical control element within the set of physical control elements; and updating the first binding information to indicate an association between the first application program action and the control element signal that is generated in response to user interaction with the first physical control element.

Updating the first binding information can occur within the application program execution context. According to an aspect of the disclosure, each of retrieving first relationship information, retrieving configuration information, retrieving first binding information, and updating the first binding information occurs within the application program execution context.

According to an aspect of the disclosure, a system for managing one or more relationships between a set of physical control elements carried by an input device and a set of user-selectable actions performed by an application program includes a processing unit; an input device coupled to the processing unit, the input device carrying the set of physical control elements and configured to generate a control element signal in response to user interaction with at least one physical control element within the set of physical control elements; and a memory coupled to the processing unit.

The memory includes an application program, which can correspond to a computer game (e.g., an MMO game client). The memory further includes an input device mapping module that includes a set of program instructions for graphically defining and maintaining a set of application program action—physical input device control element relationships in response to user input in a manner that retains consistency between the execution of application program actions and user interaction with physical input device control elements following one from the group of an input device firmware reconfiguration and an input device driver reconfiguration. The input device mapping module can execute within the execution context of the application program, and according to an aspect of the disclosure the input device mapping module corresponds to an add-on to the application program.

### BRIEF DESCRIPTION OF THE DRAWINGS

Particular embodiments of the disclosure are described hereinafter with reference to the following drawings, in which:

FIG. 1A is a block diagram of a computer system that includes an input device mapping module according to an embodiment of the disclosure;

FIG. 1B is a block diagram of a representative MMO client system according to an embodiment of the disclosure;

FIGS. 1C and 1D are schematic illustrations of a representative gaming mouse according to an embodiment of the disclosure;

FIG. 2A is a block diagram of a profile structure according to an embodiment of the disclosure, having representative default profile data stored therein according to an embodiment of the disclosure;

FIG. 2B is a block diagram of a profile structure having representative updated or modified profile or relationship data stored therein according to an embodiment of the disclosure;

FIG. 2C is a block diagram of a profile structure having additional representative updated or modified profile or relationship data stored therein according to an embodiment of the disclosure;

FIG. 3A is an illustration of a graphical window corresponding to a representative MMO game scene or environment according to an embodiment of the disclosure;

FIG. 3B is a first representative drag and drop operation that establishes a relationship between a “Heroic Strike” action and a physical input device control element according to an embodiment of the disclosure;

FIG. 3C is a second representative drag and drop operation that establishes a relationship between a “Battle Stance” action and a physical input device control element according to an embodiment of the disclosure;

FIG. 3D is an illustration of an updated graphical window corresponding to an MMO game scene or environment according to an embodiment of the disclosure;

FIGS. 4A-4C are schematic illustrations of a representative set of relationship maintenance sequences that can occur in accordance with an embodiment of the disclosure.

FIG. 5 is a flow diagram of a process for initiating MMO game play to facilitate the management of input device control element—MMO game action relationships in a unified or single execution context according to an embodiment of the disclosure;

FIG. 6 is a flow diagram of a process for preserving the integrity of a relationship between a physical input device control element and an application program action or action sequence across one or more firmware and/or input device driver reconfigurations according to an embodiment of the disclosure.

FIG. 7 is a flow diagram of a process for interpreting or processing input device control element signals according to an embodiment of the disclosure; and

FIG. 8 is a flow diagram of a process for managing relationships between physical input device control elements and application program functions according to an embodiment of the disclosure.

### DETAILED DESCRIPTION

Various embodiments of the present disclosure are directed to systems, devices, user interfaces, methods, procedures, and/or techniques for selectively and dynamically establishing or maintaining relationships between physical input device controls or control elements and particular application program operations, functions, actions, action sequences, and/or action keys. Such relationships can be selectively and seamlessly established and maintained within the execution context of an application program such as a game, in a manner that accounts for a configuration, reconfiguration, programming, or reprogramming of firmware and/or a device driver corresponding to an input device under consideration, where such reconfiguration may occur outside of the application program's execution context. As further detailed below, multiple embodiments of the present disclosure facilitate the generation of a graphical user interface (GUI) through which relationships or correspondences between physical input device control elements and application program operations, functions, actions, action sequences, and/or action keys can be visually established and maintained in a consistent, persistent, and readily understood manner.

In general, an input device in accordance with the present disclosure can be essentially any type of wire-based or wireless computer system peripheral that generates and outputs electromagnetic signals in response to particular types of user interaction or manipulation. Representative types of input devices applicable to various embodiments of the present disclosure can include one or more of a mouse (e.g., a gaming mouse), a trackball, a joystick or analog stick, a pointing stick, a touchpad or multi-touch pad, a touch screen, a game console controller, a keyboard, a headset or head-worn device, a device to facilitate signal communication in a virtual reality environment, or other type of device.

An input device typically carries a set of interface or control elements, structures, or mechanisms. The input device is structurally and/or functionally configured to output an electromagnetic signal in response to a user's interaction with or selection of one or more control elements. An input device control element can include essentially any type of transducer or transducing element. For instance, an input device control element can include a button (e.g., a mouse button); a wheel (e.g., a scroll wheel or thumb wheel); a ball; a lever; a slider; a pressure or touch sensitive interface (e.g., a pad or screen, which can be responsive to a stylus); a key; a switch; a motion, orientation, or acceleration sensor; a light-based device (e.g., an LED, a laser, and/or a photodetector); a set of electrodes; and/or other type of element.

In response to user interaction with an input device control element (e.g., by way of user selection, manipulation, or actuation of the control element, or control element sensing), input device firmware and/or a device driver associated with the input device generate a set of corresponding control element signals, messages, and/or events. The firmware and/or the device driver can communicate, issue, output, or transfer the set of control element signals to a currently-executing application program for processing. The firmware and/or the device driver can generate the set of control element signals in accordance with a default control element to control element signal mapping, or in accordance with a modified control element to control signal mapping in the event that a firmware or device driver reconfiguration or programming process has occurred. Typically, the device driver is based upon or derived in accordance with a class protocol (e.g., the USB Human Interface Device (HID) class).

As described in detail below, various embodiments of the present disclosure involve a computer system or computing device on which an application program and a corresponding input device mapping module execute. The input device mapping module facilitates the display of GUI widgets and/or other graphical elements directed to managing relationships between particular physical input device control elements and application program operations or actions. The input device mapping module manages such relationships in a manner that accounts for changes to mappings (e.g., established or selected by way of firmware or device driver reconfiguration) between physical input device control elements and control element signals while maintaining an application program's execution continuity. In several embodiments, the input device mapping module corresponds to a set of program instructions that can exist as a portion of an application program's execution process. For instance, following or during the establishment of an application program execution context or process by way of application program loading and initialization, an input device mapping module can be loaded and initialized such that program instructions corresponding to the input device mapping module are executable within the application program's execution context.

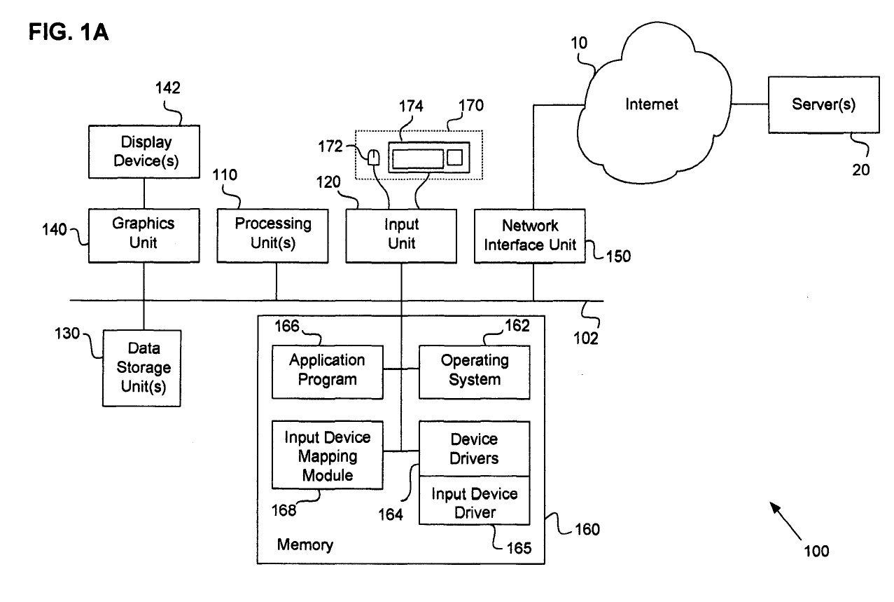

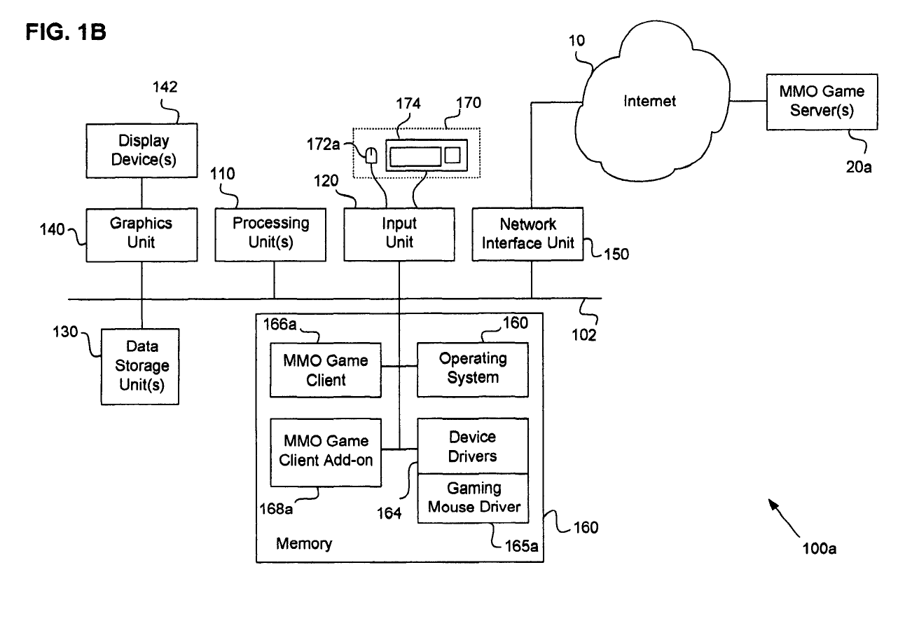

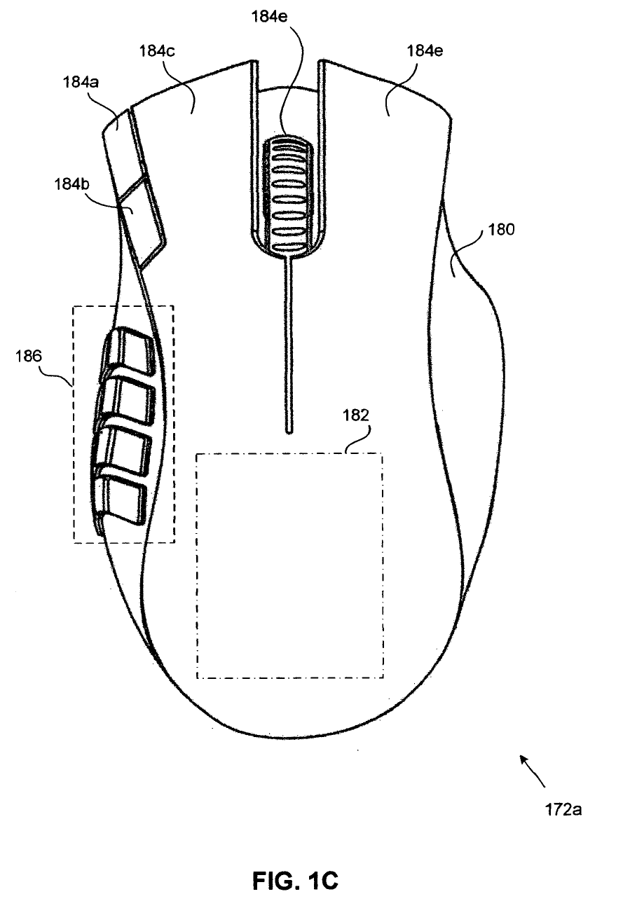

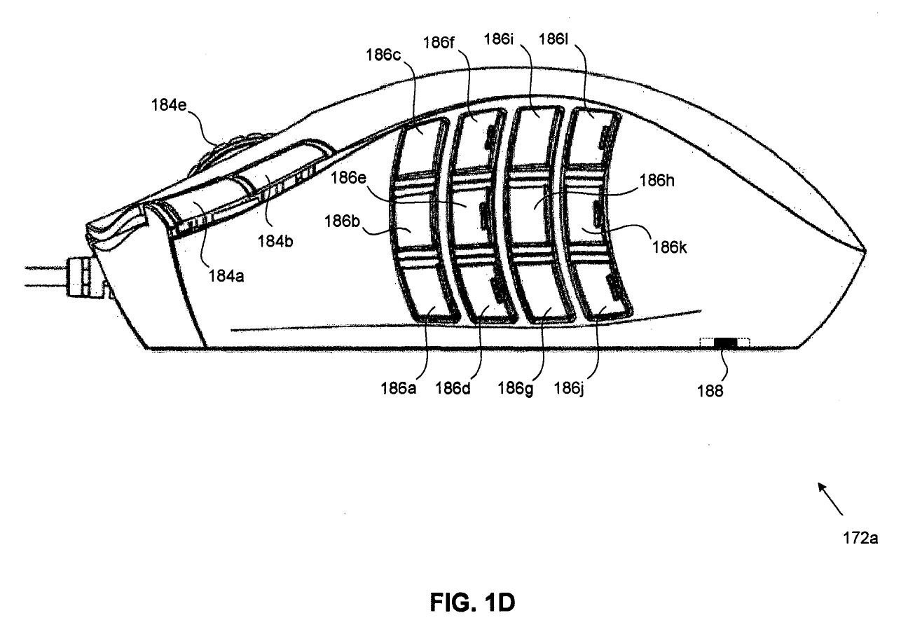

FIG. 1A is a representative block diagram of a computer system or computing device 100 that incorporates at least one input device mapping module 168 in accordance with an embodiment of the disclosure. In the embodiment shown, the computer system 100 includes a processing unit 110; an input unit 120 coupled to one or more input devices 170 such as a mouse 172, a keyboard 174, and/or other device (e.g., a particular type of gaming input device, or a game console controller); a data storage unit 130; a graphics unit 140 coupled to a set of display devices 142; and a network interface unit 150 coupled to a computer network such as a Local Area Network (LAN), a Wide Area Network (WAN), and/or the Internet 10. The computer system 100 further includes a memory 160 in which an operating system 162, a set of device drivers 164, one or more portions of an application program 166, and an input device mapping module 168 reside. The set of device drivers 164 includes at least one device driver 165 corresponding to at least one input device 170 under consideration. Finally, the computer system 100 additionally includes at least one bus 102 (e.g., a PCI based bus) to which each computer system element is coupled to facilitate the communication or exchange of control signals and data.

The processing unit 110 includes one or more processors (e.g., at least one microprocessor and/or microcontroller) capable of executing stored program instructions. The data storage unit 130 includes one or more types of fixed and/or removable data storage devices or elements, as well as storage media corresponding thereto. For instance, the data storage unit 130 can include a hard disk drive, a DVD or CD-ROM drive, and/or a USB flash drive. The memory 160 includes one or more types of volatile and/or nonvolatile memory, such as a register set, Random Access Memory (RAM), and Read Only Memory (ROM). Portions of the data storage unit 130 and/or the memory 160 can form one or more computer programmable or readable media on which portions of an application program 166 and/or an input device mapping module 168 according to an embodiment of the disclosure reside (e.g., as sets of program instructions).

Depending upon embodiment details, the computer system 100 shown in FIG. 1A can be a client system that communicates with one or more servers or a server farm 20 in accordance with a client-server computing architecture and corresponding client-server communication protocol. Alternatively, the computer system 100 can be a peer system that communicates with other computer systems or computing devices in accordance with a peer-to-peer computing protocol. As yet another alternative, the computer system 100 can be an isolated or stand-alone system.

In various embodiments, one or more portions of the input device mapping module 168 can include at least one add-on that is directed to a particular application program 166 under consideration. Typically, an add-on includes program instructions that augment, enhance, or extend the functionality or capabilities of an application program 166 (e.g., beyond a base set of application program functional capabilities). In association with such program instructions, an add-on may include or define a set of variables for storing signals or data on a temporary or persistent basis. An add-on may further include GUI widgets, graphical display information, data structures and/or data that are relevant for modifying the visual appearance of graphical windows generated during application program execution. Such information can be stored in appropriate types of files that are associated with and accessible to the add-on. In general, an add-on can include extensions, which add to or modify an application program's base functionality; and themes, which add to or modify the content of graphical windows through which a user interacts with the application program 166.

An add-on can be generated or written in accordance with an application program interface (API) corresponding to the application program 166 under consideration. An installation process can identify or register the add-on as program code and possibly related information that are regularly loaded into memory 160 in association with the application program's normal loading or initialization process. Thus, upon loading, the add-on's program instructions can essentially become a set of directly executable sub-processes, routines, or functions within application program 166 itself. Therefore, once loaded, the add-on can integrally execute as part of the application program's execution process. The additional capabilities provided by the add-on can be activated or performed in the context of the application program's normal execution process, without interrupting, disrupting, or terminating this normal execution process.

For purposes of brevity and clarity, particular aspects of various embodiments of the disclosure are henceforth described in the context of a computer system 100 that is configured as a client capable of communicating with a set of networked servers 20 to facilitate the persistent execution of an MMO game. The MMO game can be, for instance, an MMO Role Playing Game (MMORPG), an MMO Real Time Strategy (MMORTS) game, an MMO First Person Shooter (MMOFPS) game, an MMO Social Game (MMOSG), an MMO Sports Game (MMOSG), or other type of MMO game. To further aid understanding, a client input device 170 that facilitates interactions between a gamer and the MMO game is defined to include a mouse 172. The foregoing considerations, however, do not preclude the applicability of one or more embodiments of the disclosure to other systems, devices, techniques, and/or processes in which fundamental or specific aspects of particular embodiments, such as operational, functional or performance characteristics, are desired.

FIG. 1B is a block diagram of a representative MMO client system or MMO client computing device 100a according to an embodiment of the disclosure. In FIG. 1B, like or analogous reference numbers can indicate like or analogous elements relative to FIG. 1A. In the MMO client system 100a, an application program 166 can be an MMO game client 166a that provides a user interface (UI) to facilitate the input and processing of gamer instructions, commands, and data. The MMO game client 166a can also include or access a graphical display engine (e.g., a 3D engine) for displaying and updating a graphical game environment; and a client-server communications manager. In a representative implementation, the MMO game client 166a can be a World of Warcraft® or other MMO client. The MMO client system 100a can be coupled to a set of MMO game servers or an MMO server farm 20a to facilitate client—server based game play.

An input device mapping module 168 of the MMO client system 100a can include one or more MMO game client add-ons 168a In some embodiments, a given MMO game client add-on 168a corresponds to a specific type of input device 170, for instance, a particular make and model of mouse 172. In such embodiments, a distinct MMO game client add-on 168a can correspond to each distinct type of input device 170 that a gamer may utilize during game play. In a representative implementation, the MMO game client add-on 168a can be a World of Warcraft® add-on.

In the representative MMO client system 100a, a mouse 172 can be a gaming mouse 172a, which can include one or more independently configurable or programmable control elements. FIGS. 1C and 1D are schematic views of a representative embodiment of a gaming mouse 172a that is suitable for use in various embodiments of the present disclosure. This gaming mouse 172a includes a housing 180 that carries one or more control elements 184a-e and/or control element sets 186. Particular control elements can be independently configurable or programmable. In the embodiment shown, the representative gaming mouse 172a includes a first top button 184a, a second top button 184b, a third top button 184c, a fourth top button 184d, a scroll wheel 184e, and at least one side button matrix or array 186. In this embodiment, the side button array 186 includes a first through a twelfth side button 186a-1.

In some embodiments, the side button array 186 includes a number of physical control elements that generally corresponds or corresponds to or matches a number of graphical action buttons supported by the MMO game client 166, as further detailed below. Additionally, in certain embodiments, some or all of the physical control elements 184a-b, 186a-1 carried by the MMO gaming mouse 172a (e.g., the side buttons 186a-1 within the side button array 186) can be spatially arranged in a manner that corresponds to or matches a portion of a user interface or a set of controls carried by another type of electronic device (e.g., a portable or mobile electronic device) that is expected to be known, commonly known, or commonly encountered by a gaming mouse user or other individual. As a representative example, the first through twelfth side buttons 186a-1 can be spatially organized in a manner that corresponds to and is indicative of the arrangement of keys on a mobile telephone keypad. As another representative example, particular gaming mouse physical control elements can spatially and functionally correspond to a set of control elements carried by a hand held gaming device or console. As yet another representative example, a gaming mouse 172a can carry (e.g., on a right side or surface) one or more physical control elements that are spatially and/or functionally organized in a manner that corresponds to a set of control elements carried by a portion of a personal audio device. For instance, a gaming mouse 172a can carry a multidirectional selection button and/or other type of control element that is analogous to a control element carried by an Apple iPod (Apple Computer Corp., Cupertino, Calif.).

The gaming mouse 172a can also carry an on-board configuration unit 182 that includes hardware (e.g., a memory and/or a microcontroller) and possibly firmware that facilitates the definition or selection of one or more configuration profiles, where each configuration profile identifies a set of control element to control element signal mappings as further detailed below. On-mouse selection of a particular configuration profile can be facilitated by a switch or slider 188 carried by the gaming mouse 172a (e.g., on a bottom surface), and possibly a visual indicator (e.g., an LED) carried by the gaming mouse 172a.

The gaming mouse 172a additionally includes a position sensing unit (e.g., an optical position detector), and a wire-based or wireless communication link (not shown) that facilitates communication with the MMO client system 100a. The gaming mouse 172a further includes appropriate types of circuitry carried by the housing 190 to facilitate signal transfer (e.g., an RF or optical wireless transmitter, and possibly a power source), in a manner understood by one of ordinary skill in the art. While FIGS. 1C and 1D illustrate a given representative type of gaming mouse 172a, various embodiments of the disclosure are applicable to other gaming mouse types, and/or other types of input devices 170. For instance, other representative examples of gaming mice 172a that are suitable for use with various embodiments of the present disclosure include the Razer Copperhead™, the Razer Lachesis™ (Razer USA Ltd., www.razerzone.com), and/or another type of gaming mouse 172a.

The gaming mouse 172a is responsive to gamer interaction, manipulation, or actuation in one or more manners previously indicated, where such interaction corresponds to instructions or commands that facilitate MMO game play. Communication between the gaming mouse 172a and the MMO game client 166a or the MMO game client add-on 168a is facilitated or managed by gaming mouse firmware and/or a gaming mouse device driver 165a. The MMO game client 166a and the MMO game client add-on 168a facilitate various types of standard graphical user interface operations, such as item selection, drag and drop operations, and conventional window management functions (e.g., window opening, resizing, or closing) in response to gaming mouse input in a manner understood by one of ordinary skill in the art.

In various embodiments, during or as part of MMO game client execution, the MMO game client add-on 168a processes or interprets signals, events, or messages generated or output by the gaming mouse firmware and/or the gaming mouse device driver 165a, in a manner that prevents or avoids action, action sequence, action button, and/or action key binding mismatch. In various embodiments, an MMO game client add-on 168a includes a set of program instructions directed toward graphically defining and managing gamer-defined relationships between physical input device control elements and action sets, action buttons, or action keys supported by the MMO client application 166a. Such an MMO game client add-on 168a further includes or provides at least one graphical widget corresponding to the gaming mouse 172a, and possibly a corresponding visual or graphical representation of the gaming mouse 172a that identifies particular control elements that the gaming mouse 172a carries. Particular aspects of an MMO game client add-on 168a that dynamically facilitate the definition and modification of gamer-defined relationships between physical gaming mouse control elements and MMO game actions, action sequences, or action keys supported by the MMO game client 166a are described in detail below.

To facilitate the maintenance of consistent relationships between physical control elements and MMO game actions or action sequences regardless of one or more firmware and/or input device driver reconfigurations, in various embodiments an MMO game client add-on 168a generates or maintains a profile or profile data that indicates or stores a set of relationships between physical gaming mouse control elements and MMO game actions or action sequences. Manners in which particular embodiments of the disclosure utilize profile information or data to facilitate such relationship consistency are detailed below.

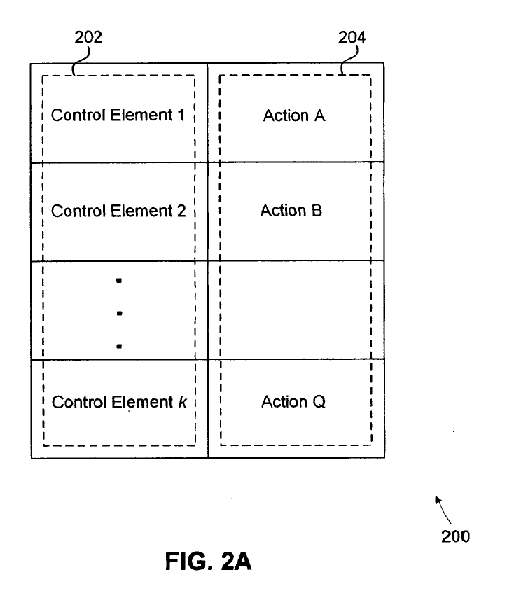

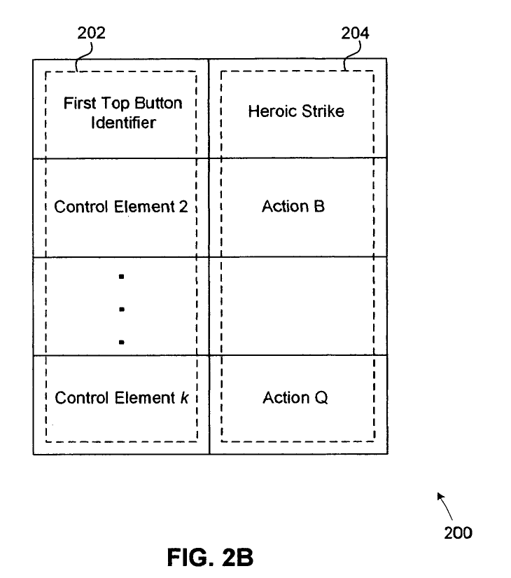

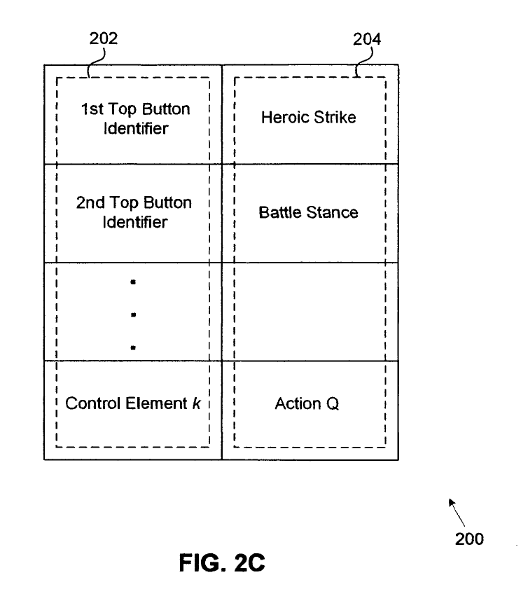

FIG. 2A is a block diagram of a representative profile structure 200 according to an embodiment of the disclosure. In one embodiment, the profile structure 200 includes a data structure having a first set of data fields 202 for storing a physical control element identifier, such as a textual or numeric identifier corresponding to a gaming mouse control element 184a-b, 186a-1. The profile structure 200 further includes a second set of data fields 204 for storing a reference to or an identifier for an application program action, action sequence, action button, or action key, for instance, a textual or numeric identifier corresponding to an MMO game action. An MMO game client add-on 168a can store or update particular information in a profile structure 200 in accordance with relationship management operations, as further detailed below. In a representative implementation, a profile structure 200 can include a list or table. In certain embodiments, a profile structure 200 can be a part of a larger data structure that stores MMO game related information.

Upon loading, an MMO game client add-on 168a can determine or retrieve configuration information for the gaming mouse 172a, where such configuration information includes mapping data that specifies one or more mappings between gaming mouse control elements and control element signals. As described in detail below, the MMO game client add-on 168a can determine whether an action initiation error would arise in response to gamer selection of a physical gaming mouse control element that is intended to initiate an MMO game action or action sequence as defined by relationship data stored within a profile structure 200. The MMO game client add-on 168a can appropriately update an MMO game action or action key binding to eliminate a binding mismatch and establish consistency between a given MMO game action or action sequence and a physical gaming mouse control element that is intended to initiate the action or action sequence.

At any given time, control element to control element signal mapping data can conform or correspond to a default firmware or device driver configuration, or a modified or updated firmware or device driver configuration. In some embodiments, the MMO game client add-on 168a can query gaming mouse firmware or a gaming mouse device driver to determine or retrieve such mapping data. In certain embodiments, the MMO game client add-on 168a can access memory locations and/or a file residing on a data storage unit 130 to retrieve mapping data. In one embodiment, a device driver 165a can include program instructions directed toward storing configuration information in particular locations or files to facilitate add-on access to such information.

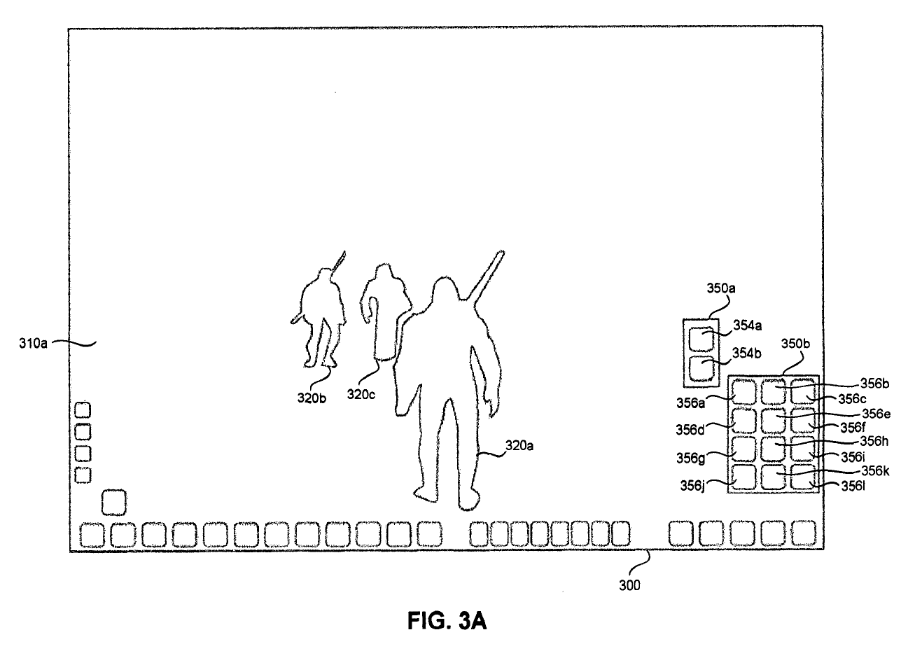

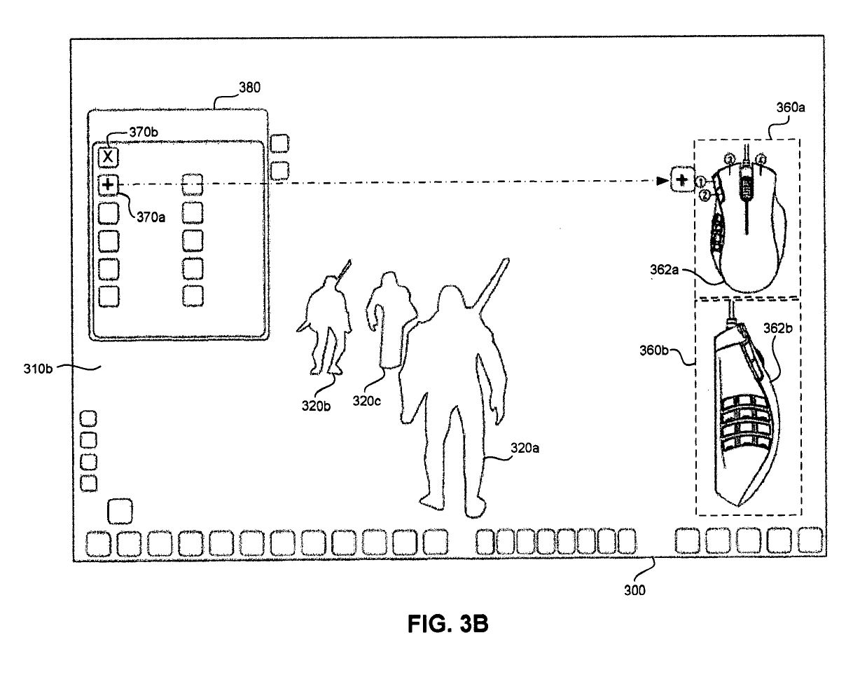

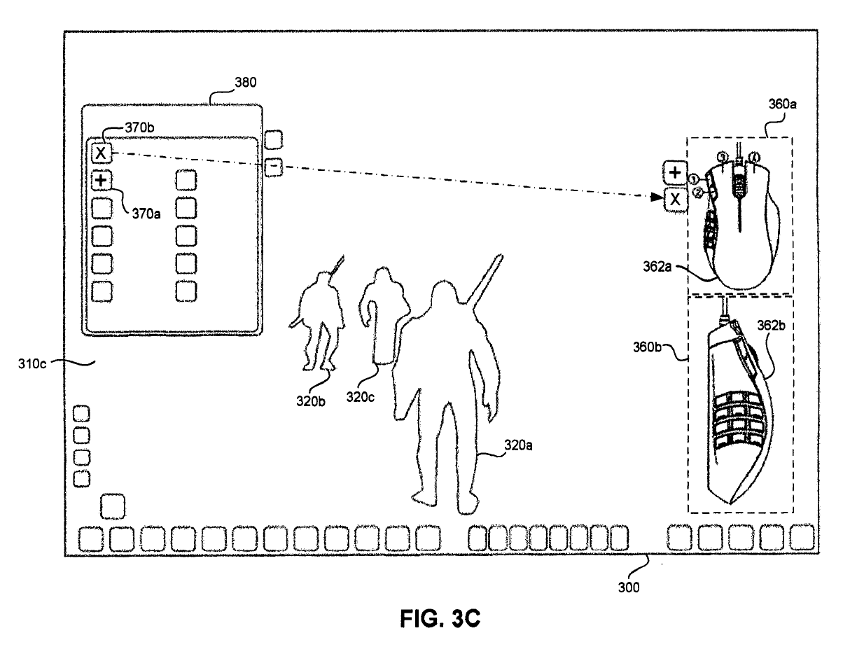

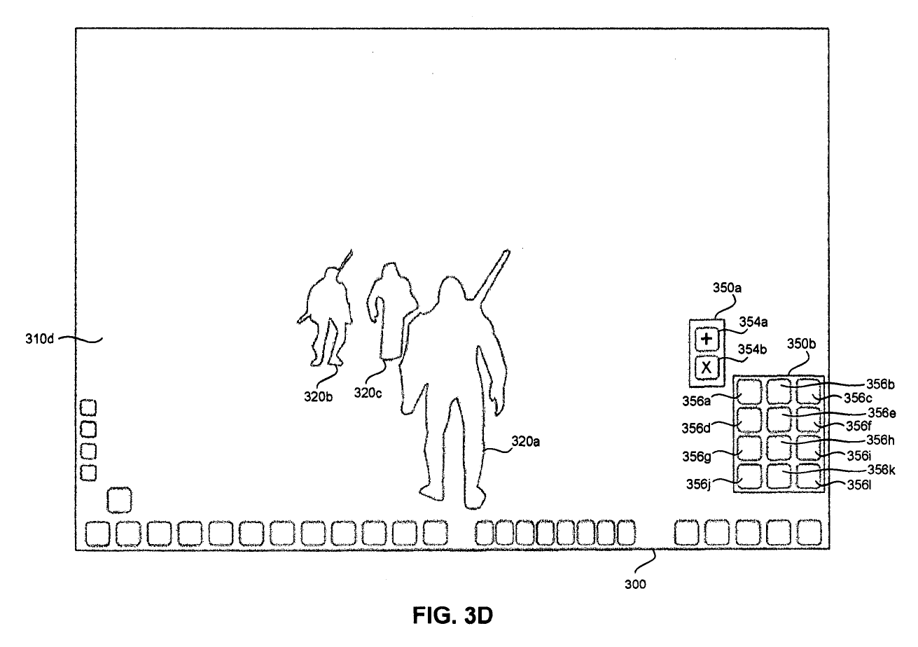

FIG. 3A is an illustration of a graphical window 300 in which game content corresponding to a representative MMO game scene 310a is displayed. In general, the representative MMO game scene 310a includes graphical elements corresponding to representations of objects that can be encountered in a virtual game environment, and one or more character avatars 320. Such character avatars 320 can include a character avatar 320a under the direct control of the client system gamer, as well as character avatars 320b, 320c corresponding to other players and/or avatars generated by and acting under the direction of the MMO game itself. The MMO game scene 310a further includes graphical elements and/or text that provide information relating to game actions or action sequences currently available to the gamer, as well as current character avatar characteristics, status, and abilities or skills.

In accordance with an embodiment of the disclosure, the MMO game client add-on 168a augments or modifies the MMO game scene 310a to include one or more gaming mouse widgets corresponding to physical characteristics or attributes of the gaming mouse 172a itself. In one embodiment, each gaming mouse widget includes a set of graphically distinct widget elements that visually correspond to a condensed (e.g., generally unobtrusive in terms of size and color) and possibly abstracted representation of particular gaming mouse control elements 172a. For instance, a first gaming mouse widget can include a first number of widget elements, each of which represents a given control element within a first set or subset of add-on assignable physical gaming mouse control elements. A second gaming mouse widget can include a second number of widget elements, each of which represents a given control element within a second set or subset of add-on assignable physical gaming mouse control elements. The arrangement or position of widget elements within a gaming mouse widget can indicate an arrangement or position of particular physical control elements relative to each other as carried by the input device 170. From a visual standpoint, a particular widget element can have, for instance, a simple geometric shape (e.g., a square, rectangular, or elliptical shape).

An MMO game client 166a can provide garners with a standard graphical interface such as an “action bar” that includes a set of graphical “action buttons.” An action bar graphically facilitates gamer-defined associations or bindings between a character avatar's available skills or spells and action buttons on the action bar. Such bindings can be established by way of drag and drop operations. Gamer selection of an action button to which a skill or spell is bound results in the performance of the skill or spell. An MMO game client 166a can further provide garners with another standard graphical interface such as a key binding menu that enables a given action button to be assigned or bound to a particular input device control element signal.

In various embodiments of the disclosure, a gaming mouse widget generated by the MMO game client add-on 168a can include one or more gaming mouse action bars 350a, 350b. Each gaming mouse action bar 350a, 350b includes an action button configuration that visually corresponds to or matches the physical layout of particular gaming mouse control elements. For instance, a first gaming mouse action bar 350a can include a first gaming mouse action button 354a and a second gaming mouse action button 354b that are graphically configured or arranged relative to each other in a manner that visually corresponds to the layout of the first and the second top gaming mouse buttons 182a, 182b shown in FIGS. 1C and 1D. Similarly, a second gaming mouse action bar 350b can include a first through a twelfth gaming mouse action button 356a-1 that are graphically organized in a manner that visually corresponds to the layout of physical control elements within such a gaming mouse's side button array 186.

In various embodiments, in response to user input that opens or selects a gaming mouse action bar 350a, 350b (e.g., by way of a mouse click or double click on or proximate to a given gaming mouse action button 354a-b, 356a-1, or a drag and drop operation involving the graphical transfer of an icon corresponding to a game action to or proximate to a gaming mouse action button 354a-b, 356a-1) the MMO game client add-on 168a further augments or modifies the MMO game scene 310a to facilitate the definition, redefinition, or deletion of physical control element to virtual game action relationships, as described in detail hereafter.

FIGS. 3B and 3C provide illustrations of a graphical window 300 displaying a first and a second representative relationship management interface 360a, 360b within a modified MMO game scene 310b. In several embodiments, the MMO game client add-on 168a displays one or more relationship management interfaces 360a, 360b in response to gamer selection of a gaming mouse action bar 350a, 350h or a gaming mouse action button 354a-b, 356a-1. In some embodiments, a relationship management interface 360a, 360b includes an image, picture, or visual representation 362a, 362b of the gaming mouse 172a that itself includes visual representations of at least one or more add-on assignable or bindable gaming mouse control elements. A relationship management interface 350a, 360b can visually indicate an arrangement, layout, or position of one or more physical input device control elements relative to each other and/or the input device housing 180. A gaming mouse's visual representation 362a, 362b can further include a number of visual control element designations or labels (e.g., numbers or letters) indicative of or corresponding to particular gaming mouse control elements, where a given label can include text and/or graphical elements.

As a representative example, for the representative gaming mouse 172a described above in relation to FIGS. 1C and 1D, a first gaming mouse visual representation 362a can include one or more control element labels that correspondingly represent one or more of the gaming mouse's first top button 182a, second top button 182b, third top button 182c, fourth top button 182d, and scroll wheel 182e. A second gaming mouse visual representation 362b can include one or more control element labels that correspondingly represent particular buttons within the gaming mouse's side button array 186. FIG. 3B depicts a first gaming mouse visual representation 362a that includes a first label (i.e., “1”) and a second label (i.e., “2”) that visually represent the gaming mouse's first and second top buttons 184a, 184b; and a second gaming mouse visual representation 362b that includes a first through a twelfth label (i.e., numbers “1” through “12”) that visually represent each side button 186a-1 in the gaming mouse's side button array 186.

The MMO game client 166a and the MMO game client add-on 168a facilitate drag and drop operations that enable a gamer's transfer of action, action sequence, or action key icons 370a, 370b displayed in one or more action, action sequence, or action key menus or subwindows 380 into, onto, or within the positional scope of a relationship management interface 360a, 360b.

In response to a gamer's positioning of such an icon 370a, 370b at or proximate to a particular control element label, the MMO game client add-on 168a updates a corresponding control element identifier and/or an action, action sequence, or action key identifier stored within the profile structure 200 that the MMO game client add-on 168a maintains for the gaming mouse 172a. Additionally, the MMO game client add-on 168a and/or the MMO game client 166a establish an assignment or binding between the action, action sequence, or action key corresponding to such an icon 370a, 370b and a control element signal that is currently mapped to the control element that corresponds to the control element label at or proximate to which the identifier 370a, 370b was positioned.

To aid understanding, a first representative drag and drop operation that associates a “Heroic Strike” action with a first control element label (i.e., the number “1” within the first relationship management interface 360a) that represents or corresponds to the first top button 184a carried by the gaming mouse 172a is illustrated in FIG. 3B. The first representative drag and drop operation involves the transfer of a “Heroic Strike” icon 370a to a particular position within the first relationship management interface 360a, as illustrated in further updated game scene 310b. A first representative set of updated profile data that the MMO game client add-on 168a can store within the profile structure 200 as a result of this “Heroic Strike” icon drag and drop operation is shown in FIG. 2B. This “Heroic Strike” icon drag and drop operation further results in the MMO game client add-on 168a and/or the MMO game client 166 generating or updating binding information or data that defines an assignment or binding between the “Heroic Strike” action and the control element signal that is currently mapped to the first top button 184a.

Similarly, another updated game scene 310c shown in FIG. 3C illustrates a second representative drag and drop operation that associates a “Battle Stance” action with a second control element label (i.e., the number “2” within the first relationship management interface 360a) that represents the second side button 184b carried by the gaming mouse 172a. This second drag and drop operation involves a “Battle Stance” icon 370b. A second representative set of updated profile data that the MMO game client add-on 168a can store in the profile structure 200 in response to this “Battle Stance” icon drag and drop operation is shown in FIG. 2C. This “Battle Stance” icon drag and drop operation further results in the MMO game client add-on 168a and/or the MMO game client 166 generating or updating binding information that defines an assignment or binding between the “Heroic Strike” action and the control element signal that is currently mapped to the second top button 186a.

In response to the gamer closing a relationship management interface 360a, 360b (e.g., in response to a mouse click), the MMO game client add-on 168a can (re)display a gaming mouse action bar 350a, 350b. A gaming mouse action bar's appearance can be appropriately updated to indicate or reflect any relationships between MMO game actions and physical gaming mouse control elements that were established, and any assignments or bindings that occurred, while the relationship management interface 360a, 360b was open or active. As shown in FIG. 3D, the first and second action buttons 354a, 354b within the first gaming mouse action bar 350a are respectively updated to visually include or graphically carry the “Heroic Strike” and “Battle Stance” icons. Thus, the first action button 354a visually indicates that the “Heroic Strike” action can be initiated in response to user selection of the gaming mouse's first top button 184a, and the “Battle Stance” action can be initiated in response to user selection of the gaming mouse's second top button 184b.

In some embodiments, an arrangement of action buttons 354a-b, 356a-1 within a gaming mouse action bar 350a, 350b can be dynamically modified or updated in response to gamer input. For instance, in certain situations, a gamer may drag an action icon 370a, 370b to a control element label (e.g., the number “3” or “4” within the first gaming mouse action bar 350a) that doesn't correspond to an action button (e.g., the first or second gaming mouse action button 354a, 354b) shown within a gaming mouse action bar's most recently displayed action button arrangement. In response, in some embodiments the MMO game client add-on 168a can automatically 1) establish an appropriate binding and relationship respectively pertaining to the control element signal and the physical control element for the control element label under consideration; and 2) modify the gaming mouse action bar's action button arrangement such that it appropriately includes a new action button corresponding to the physical control element for which the MMO game client add-on 168a established this relationship. Such a new action button can be displayed at a gaming mouse action bar position that reflects the physical location of the action button's counterpart physical control element carried by the gaming mouse 172a.

In addition to the foregoing, in response to a drag and drop operation that moves an icon away from or out of a gaming mouse action button 354a-b, 356a-1, the MMO game client add-on 168a can delete a previously established physical control element—game action/action sequence/action key relationship, and a corresponding control element signal—game action/action sequence/action key binding. In some embodiments, the MMO game client add-on 168a can reset previously established relationships and bindings to a set of default relationships and bindings (e.g., in response to user input).

While the representative drag and drop operations illustrated in FIGS. 3B and 3C correspond to the first gaming mouse action bar 350a and the first relationship management interface 360a, drag and drop operations involving the second action bar 350a and the second relationship management interface 360a can establish relationships between physical gaming mouse control elements and MMO game actions, as well as bindings between gaming mouse control element signals and game actions, in an identical or analogous manner to that described above.

In some embodiments, in response to a drag and drop operation in which a game action icon 370a, 370b is directly transferred to a particular graphical action mouse button 354a-b, 356a-1, the MMO game client add-on 168a can establish a relationship between the indicated physical gaming mouse control element and the game action under consideration, and establish a binding between the control element signal that is presently mapped to the physical gaming mouse control element and the game action under consideration. In such embodiments, opening or activating a relationship management interface 360a, 360b may be optional or unnecessary for establishing the aforementioned relationship and binding. Moreover, in certain embodiments, a relationship management interface 360a, 360b can facilitate the user selection or identification of particular physical gaming mouse control elements 184a-e, 186a-1 for which gaming mouse action buttons 354a-b, 356a-1 are to be displayed in a gaming mouse action bar 350a, 350b (e.g., in response to a right click or other user input), thereby facilitating gaming mouse action bar customization.

In some embodiments, a given MMO game client add-on 168a can correspond to or manage physical control element—game action relationships for a particular type or model of gaming mouse 172a or input device 170. That is, a distinct MMO game client add-on 168a can exist for each unique type of input device 170 that is capable of facilitating user interaction with the MMO game client 166a. In other embodiments, a given MMO game client add-on 168 can manage such relationships for one or more categories of input devices, for instance, a number or range of input device models produced by a particular input device manufacturer.

A portion of an MMO game client 166a and/or an MMO game client add-on 168a (e.g., program instructions corresponding to a loading and initialization manager) and/or other software can facilitate MMO game client add-on retrieval or download operations in which one or more portions of an MMO game client add-on 168a that is appropriate for an input device in use or under consideration (e.g., as determined automatically, or in response to user identification or selection) is transferred to the MMO client system 100. An appropriate MMO game client add-on 168a for a given input device 170 can be downloaded, for example, from a server coupled to the Internet. In certain embodiments, an MMO game client add-on 168a can include program instructions for determining or retrieving input device design information that specifies a number, nature, and/or organization of control elements for one or more input devices that are coupled to the MMO client system 100. Such input device design information can be stored in a local or remote (e.g., server-side) database, and retrieved or downloaded accordingly (e.g., automatically or in response to user input).

As indicated above, in response to a graphical operation (e.g., a single drag and drop operation), various embodiments of the disclosure can 1) associate an action or action sequence with a user selected or target graphical gaming mouse action button 354a-b, 356a-1; 2) automatically establish a binding between the action or action sequence and a particular control element signal that is currently mapped to the gaming mouse control element 184a-e, 186a-1 that is the physical counterpart of the target gaming mouse action button 354a-b, 356a-1; and 3) automatically establish profile data defining a relationship between the action or action sequence and this physical gaming mouse control element 184a-e, 186a-1. More generally, in response to a set of graphical operations, various embodiments of the present disclosure can 1) establish a link between an application program action (e.g., a user selectable action) and a target graphical input device action button 354a-b, 356a-1; 2) bind the application program action to the control element signal that is currently mapped to a particular physical control element corresponding to the target graphical input device action button 354a-b, 356a-1; and 3) establish a relationship between the physical input device control element and the application program action. Representative manners in which various embodiments of the disclosure seamlessly and consistently maintain physical control element—application program action relationships are further described below.

In view of the foregoing, in accordance with various embodiments of the disclosure an input device mapping module 168 can generate a graphical action widget or action bar 350a, 350b having an as-displayed appearance that visually corresponds to or matches the physical layout of particular input device control elements. Various embodiments of the present disclosure thus provide a user with an easily understood, intuitive visual association between a physical configuration, organization, arrangement, or layout of control elements carried by an input device and a graphical configuration, organization, arrangement, or layout of action buttons or action widget elements. Moreover, various embodiments of the disclosure provide a user with easily understood, intuitive visual manners of identifying and managing relationships that exist between physical input device control elements and application program actions.

In accordance with various embodiments of the disclosure, gamer interactions with a gaming mouse widget 350a, 350b and a relationship management interface 360a, 360b, as well as MMO game client add-on operations performed in response to such interactions, occur within the application process or execution context of the MMO game client 166a. Input device firmware or device driver (re)configuration or (re)programming operations occur outside of the process context of the MMO game client 166a.

As indicated above, the MMO game client add-on 168a can determine or retrieve configuration information following MMO game client add-on loading. In the event that a gamer or other user establishes or programs one or more mappings between gaming mouse control elements and corresponding control element signals via firmware or device driver configuration operations, the MMO game client add-on 168a updates binding information accordingly to ensure that relationships between particular physical control elements and game actions remain consistent. That is, the MMO game client add-on 168a maintains such relationships in a manner that ensures that a given physical gaming mouse control element will consistently initiate an intended game action or action sequence even though the control element signal generated by the gaming mouse control element has changed.

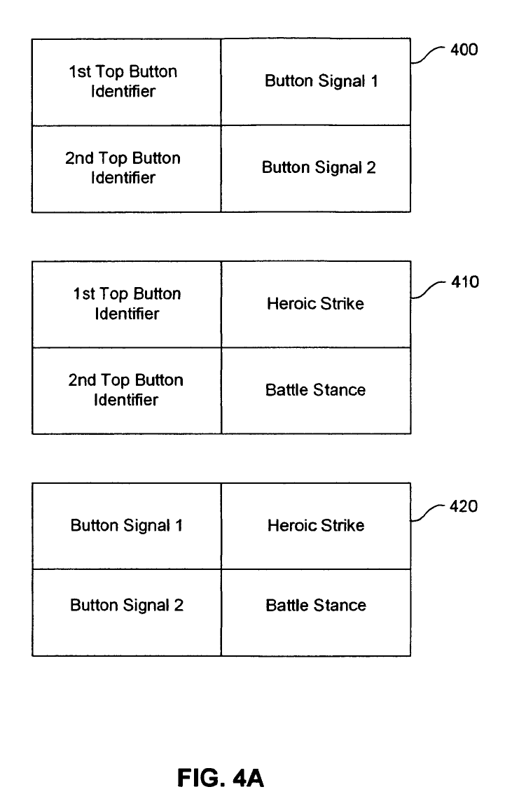

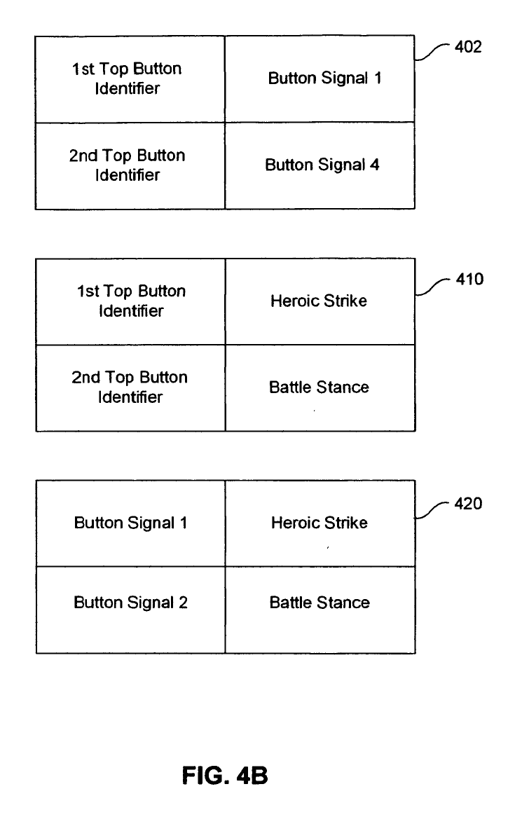

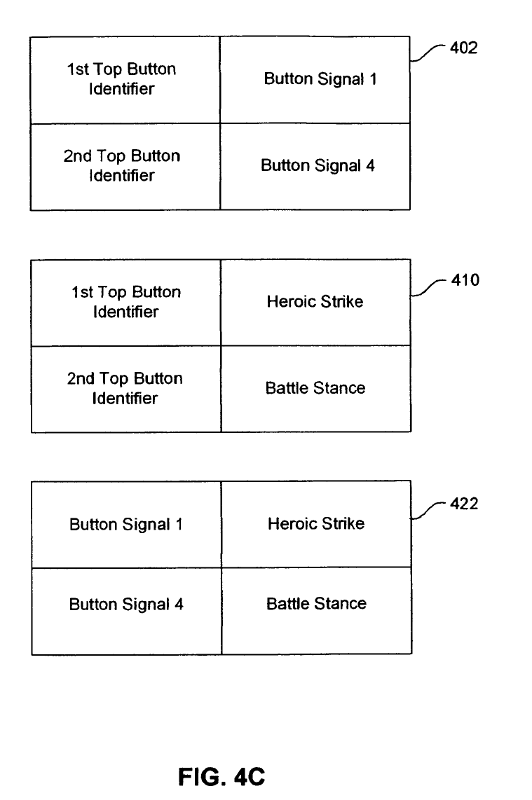

FIGS. 4A-4C are schematic illustrations of a representative set of relationship maintenance sequences that can occur or be carried out in accordance with an embodiment of the disclosure. FIG. 4A illustrates a representative first firmware or device driver configuration data set or subset 400, a representative reference set or subset of relationships 410 between particular gaming mouse control elements 184a-b, 186a-1 and specific MMO game actions or action sequences, and a representative first set or subset of bindings 420 between control element signals generated by the gaming mouse control elements 184a-b, 186a-1 and the MMO game actions or action sequences under consideration. Such control element signals are generated in accordance with the first configuration data set 400. The first configuration data set 400 is defined to be accurate or valid during a first time interval during which an MMO game client 166a and the MMO game client add-on 168a facilitate MMO game play in accordance with at least one embodiment of the present disclosure.

As indicated in FIG. 4A, the reference set of relationships 410 includes a reference to an identifier corresponding to each of the first and second top buttons 184a, 184b carried by the gaming mouse 172a, as well as a reference to a “Heroic Strike” action identifier and a “Battle Stance” identifier. The reference set of relationships 410 can reside, for example, in a portion of a profile structure 200. The reference set of relationships 410 indicates or defines a relationship 410a between the first top button 184a and the “Heroic Strike” action, and a relationship 410b between the second top button 184b and the “Battle Stance” action. In accordance with the first configuration data set 400, during MMO game play, button signal 1 is generated in response to user selection of the first top button 184a, and button signal 2 is generated in response to user selection of the second top button 184b. In response to the generation of button signal 1 or button signal 2, the MMO game 166a and/or the MMO game add-on 168a initiate the “Heroic Strike” action or the “Battle Stance” action, respectively, in accordance with the first set of bindings 420.

Between separate or successive MMO game client execution periods (e.g., after the completion or termination of an MMO game session, or during an interruption of an MMO game session), a gaming mouse firmware configuration can be updated or reprogrammed. This can result in one or more control element to control element signal remappings, and the generation of updated configuration information such a representative second configuration data set or subset 402 as shown in FIG. 4B. In the second configuration data set 402, the gaming mouse's first top button 184a remains mapped to button signal 1, but the second top button 184b has been remapped to button signal 4.

If MMO game play were undertaken following the generation of the second configuration data 402 set in the absence of any relationship maintenance operation(s), the “Heroic Strike” action would be initiated in response to gamer selection or actuation of the gaming mouse's first top button 184a, but the “Battle Stance” action would not be initiated in response to gamer selection or actuation of the second top button 184b. In the absence of any relationship maintenance operation(s), gamer actuation of the second top button 184b would result in the generation of button signal 4 rather than button signal 2. More particularly, because the first binding set 420 associates or binds button signal 2 with the “Battle Stance” action, the generation of button signal 4 in response to gamer actuation of the gaming mouse's second top button 184h would not result in the initiation of the “Battle Stance” action.

The MMO game client add-on 168a can perform one or more types of relationship management operations to maintain or ensure consistency between physical control elements and the initiation of intended MMO game actions. Depending upon embodiment details, the MMO game client add-on 168a can perform relationship management operations upon loading and prior to the start of MMO game play, and possibly upon resumption of MMO game play following MMO game play interruption.

FIG. 4C illustrates a second binding set 422 that has been appropriately generated or updated by way of one or more relationship management operations or sequences. In one embodiment, the MMO game client add-on 168a can 1) examine a relationship within the reference set of relationship data 410 to identify a particular physical gaming mouse control element 184a-b, 186a-1 and an intended MMO game action or action sequence specified for the relationship; 2) determine the button signal that is bound to the intended MMO game action in accordance with the first binding set 420; 3) determine whether the button signal bound to the intended MMO game action is mapped to the particular physical gaming mouse control element 184a-b, 186a-1 based upon the second configuration data set 402; and in the event that a mapping mismatch or inconsistency exists, 4) store an updated button signal that is presently mapped to the particular physical control element 184a-b, 186a-1 in the first binding set 420 to create the second binding set 422.

In another embodiment, the MMO game client add-on 168a can 1) examine a relationship within the reference set of relationship data 410 to identify a particular physical gaming mouse control element 184a-b, 186a-1 and an intended MMO game action or action sequence specified for the relationship; 2) determine a mapping between the particular physical gaming mouse control element 184a-b, 186a-1 and a current button signal specified by the second configuration data set 402; and 3) store the current button signal in the first binding set 420 to generate the second binding set 422.

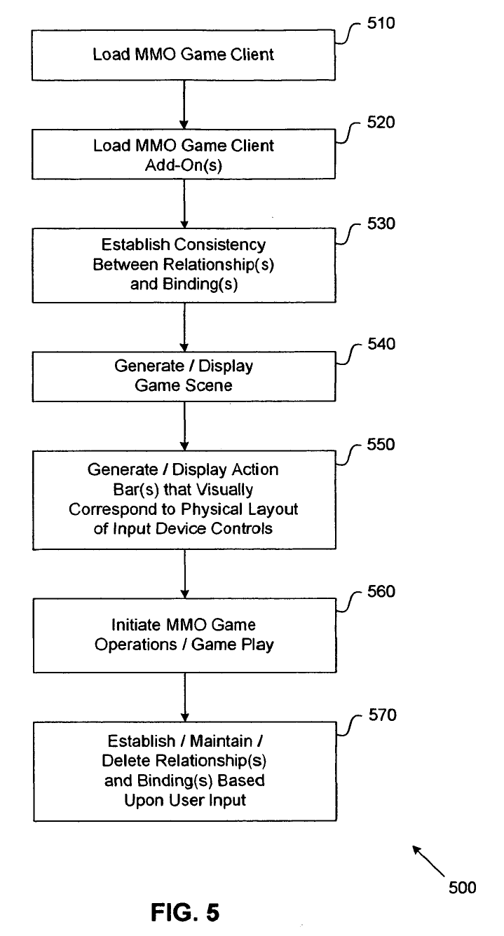

FIG. 5 is a flow diagram of a process 500 for initiating user interaction with an application program to facilitate the seamless management of input device control element—application program action relationships in a unified or single execution context according to an embodiment of the disclosure. In some embodiments, the process 500 involves initiating MMO game play in a manner that accommodates the management of input device control element—MMO game action relationships within an MMO game client's execution context. In one embodiment, the process 500 includes a first process portion 510 that involves loading and initializing an MMO game client 166a, which can establish the MMO game client's execution context. The process 500 further includes a second process portion 520 that involves retrieving, downloading, and/or loading and initializing a set of MMO game client add-ons 168a that facilitates the management of input device control element—MMO game action relationships in a manner identical, analogous, or generally analogous to that described above.

The second process portion 520 can involve identifying one or more MMO game client add-ons 168a that are appropriate for a set of input devices 170 that facilitates user communication with and control of the MMO game client 166a. In certain embodiments, an executive or management portion of one or both of an MMO game client 166a and an MMO game client add-on 168a can determine whether one or more input device specific MMO game client add-on program instruction sets reside upon a local system. A given input device specific MMO game client add-on program instruction set can include instructions or program code directed toward generating a set of input device action interfaces or action bars 350a, 350b and/or relationship management interfaces 360a, 360b that visually represent control elements and possibly other portions of the input device to which the program instruction set corresponds. In one embodiment, if a given input device specific MMO game client add-on program instruction set does not reside on a local data storage unit 130, the executive or management portion of the MMO game client 166a or the MMO game client add-on 168a can retrieve the appropriate program instruction set(s) from a remote source such as a server coupled to the Internet. The executive or management portion of the MMO game client 166a or the MMO game client add-on 168a may request, access, or retrieve input device configuration data to identify a specific input device or input device type as part of the second process portion 520.

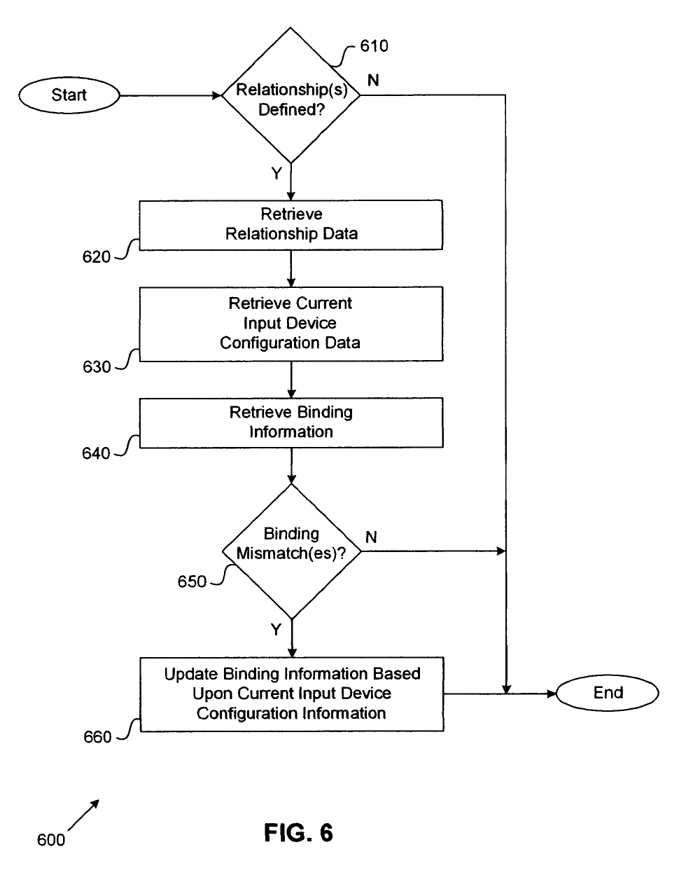

A third process portion 530 involves validating, maintaining, or establishing consistency between a set of physical input device control elements and an intended set of MMO game actions, for instance, by eliminating or correcting one or more control element signal—MMO game action mismatches prior to the initiation or resumption of MMO game play in a manner described below with reference to FIG. 6. The correction of such mismatches avoids action or action sequence initiation errors. In one embodiment, the third process portion 530 can involve accessing or retrieving one or more of profile structure data, control element to control element signal mapping or configuration data (e.g., as most recently defined by firmware or device driver configuration operations), and binding information. If a profile structure 200 does not already exist, the MMO game client add-on 168a can create or retrieve (e.g., from a local data storage unit 130 or a server-side database) an initial profile structure 200 that includes an initial or default set of physical control element identifiers. Alternatively, the MMO game client add-on 168a can generate a profile structure 200 during MMO game play in response to user interaction with a gaming mouse add-on bar 350a, 350b and/or a corresponding relationship management interface 360a, 360b.

A fourth process portion 540 involves displaying a game scene or environment, game content, character avatars, and possibly other information relevant to MMO game play. A fifth process portion 550 involves displaying a graphical widget corresponding to an input device 170. The graphical widget can include a graphical input device specific action interface (e.g., one or more gaming mouse add-on bars 350a, 350b) having one or more graphical action elements, controls, or buttons (e.g., a set of gaming mouse action buttons 354a-b, 356a-1). In various embodiments, elements of the graphical widget corresponding to the input device 170 are displayed in a manner that visually represents the physical layout or organization of particular control elements that the input device 170 carries. A sixth process portion 560 involves initiating MMO game play, and a seventh process portion 570 involves establishing, maintaining, and/or deleting physical input device control element—MMO game action relationships and control element signal—game action bindings in a manner according to an embodiment of the disclosure.

FIG. 6 is a flow diagram of a process 600 for preserving the integrity of a relationship between a physical input device control element and an application program action or action sequence across one or more firmware and/or input device driver reconfigurations according to an embodiment of the disclosure. In certain embodiments, preserving the integrity of a relationship between a physical input device control element and an application program action can involve, for instance, avoiding or correcting one or more control element signal—MMO game action binding mismatches prior to the initiation or resumption of MMO game play.

In one embodiment, the process 600 includes a first process portion 610 that involves determining (e.g., by way of accessing a profile structure 200) whether one or more relationships between a physical input device control element and an application program action, action sequence, action button, or action key exist. The process 600 includes a second process portion 620 that involves identifying or retrieving relationship data (e.g., stored within a profile structure 200) that indicates or defines one or more such relationships. The process 600 further includes a third process portion 630 that involves accessing or retrieving input device configuration data that defines a set of mappings between physical input device control elements and control element signals.

In some embodiments, the process 600 further includes a fourth process portion 640 that involves retrieving binding information between a set of input device control element signals and a set of application program actions, action sequences, action buttons, or action keys. In certain embodiments, a fifth process portion 650 involves determining for one or more relationships whether a binding mismatch exists between the retrieved binding information and the input device configuration data. In one embodiment, the fifth process portion 650 can involve using an action, action sequence, action button, or action key identifier stored as part of a relationship definition to determine a control element signal bound to the action identifier within the binding information; and determining whether a physical input device control element identified in each of the relationship under consideration and the input device configuration data is bound to this control element signal. Finally, a sixth process portion 660 involves updating the binding information with the control element signal presently bound (e.g, as specified by the current configuration data) to the physical input device control element under consideration to avoid or eliminate a binding mismatch.

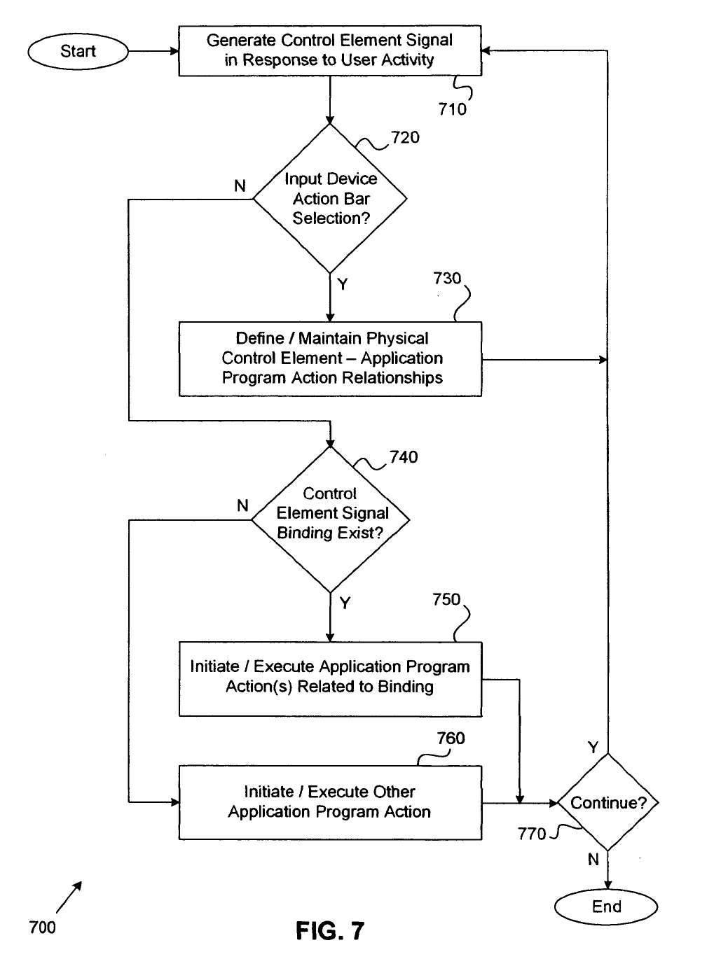

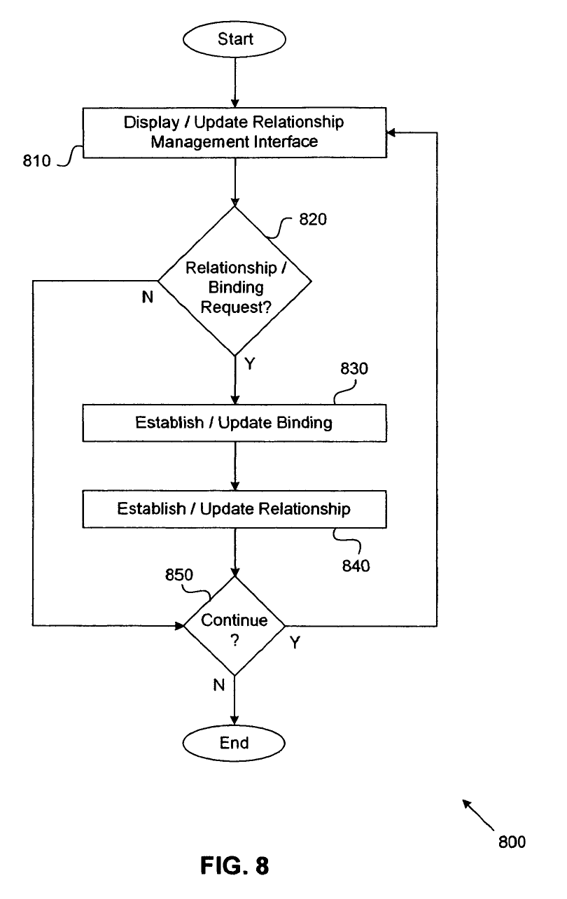

FIG. 7 is a flow diagram of a process 700 for interpreting or processing input device control element signals according to an embodiment of the disclosure. In one embodiment, the process 700 includes a first process portion 710 involving the generation of an input device control element signal in response to user selection, activation, or actuation of a given input device control element. A second process portion 720 involves determining whether the generated control element event signal corresponds to the selection of a graphical widget or graphical element associated with the input device 170, such as a gaming mouse action bar 350a, 350b or a gaming mouse action button 354a-b, 356a-1. If so, a third process portion 730 involves facilitating the definition or redefinition of physical control element—MMO game action relationships, for instance, in a manner described above with reference to FIGS. 3A-3D and/or below with reference to FIG. 8. In some embodiments, the third process portion 730 can involve displaying a relationship management interface 360a, 360b corresponding to the input device 170, and establishing one or more relationships between physical input device control elements and application program actions in response to user input.

If a control element signal corresponds to other than the selection of a graphical widget or graphical element that represents a portion of the input device 170, a fourth process portion 740 involves determining whether the control element signal is bound to an application program action such as an MMO game action, action sequence, action button, or action key. If such a binding exists, a fifth process portion 750 involves the MMO game client 166a performing or executing operations that implement the binding related action, action sequence, action button, or action key function(s). If no such binding exists, a sixth process portion 760 involves the MMO game client 166a performing of one or more other (e.g., non-bound or non-assigned) actions, tasks, or operations. Finally, a seventh process portion 770 can involve determining whether to continue. Continuing can involve returning to the first process portion 710, otherwise the process 700 can end.

FIG. 8 is a flow diagram of a process 800 for managing physical control element—MMO game action, action sequence, and/or action key relationships according to an embodiment of the disclosure. The process 800 of FIG. 8 can be performed in response to user selection of or transfer of application focus to a graphical widget or element such as a gaming mouse action bar 350a, 350b or action button 354a-b, 356a-1. In one embodiment, the process 800 includes a first process portion 810 involving displaying a relationship management interface 360a, 360b (e.g., within the displayed game environment).

A second process portion 820 involves determining whether a gamer has graphically indicated or requested 1) a new or updated relationship between an MMO game action or action sequence and a physical control element; and/or 2) an association or binding between an MMO game action or action sequence and a particular input device control element signal. Such a graphical request can include a drag and drop sequence that involves an application program icon 370a, 370b and a visual identifier associated with the input device control element under consideration. The drag and drop sequence can be a relationship definition or update request, corresponding to a drag and drop operation that transfers an application program action icon 370a, 370b to a gaming mouse or other input device action button 354a-b, 356a-1, and/or a drag and drop operation that transfers an action icon 370a, 370b to a visual identifier displayed on an input device's visual representation 362a, 362b within a relationship management interface 360a, 360b. The drag and drop sequence can alternatively be a relationship deletion request, corresponding to a drag and drop operation that transfers an application program icon 370a,1 370b away from an input device action button 370a, 370b or a visual identifier displayed on the input device's visual representation 362a, 362b.

In response to a relationship definition or update request, or in response to a relationship deletion request, a third process portion 830 involves establishing or updating an appropriate control element signal—MMO game action association or binding. The third process portion 830 can involve generating or updating binding information or data corresponding to the input device 170, in a manner identical or analogous to that previously described. Additionally, a fourth process portion 840 involves defining, updating, or deleting a relationship between the physical input device control element under consideration and the application program action or action sequence corresponding to the action icon 370a, 370b (e.g., by generating or updating a profile structure 200 accordingly).

A fifth process portion 850 involves determining whether to continue relationship management operations. Continuation of relationship management operations can involve returning to the first process portion 810. Discontinuation of relationship management operations can occur, for instance, in response the garner closing a relationship management window 360a, 360b.

Particular embodiments of the disclosure are described above for addressing at least one of the previously indicated disadvantages. While features, functions, advantages, and alternatives associated with certain embodiments have been described within the context of those embodiments, other embodiments may also exhibit such advantages, and not all embodiments need necessarily exhibit such advantages to fall within the scope of the disclosure. It will be appreciated that several of the above-disclosed and other structures, features and functions, or alternatives thereof, may be desirably combined into other different devices, systems, or applications. The above-disclosed structures, features and functions, or alternatives thereof, as well as various presently unforeseen or unanticipated alternatives, modifications, variations or improvements thereto that may be subsequently made by one of ordinary skill in the art, are encompassed by the following claims.

1. A computer based method for managing at least one relationship corresponding to a set of physical control elements carried by an input device and a set of user-selectable actions performed by an application program in response to user input, comprising:
establishing an application program execution context;
establishing a relationship between a first physical control element within the set of physical control elements and a first user-selectable action within the application program execution context; and
automatically maintaining the relationship between the first physical control element and the first user-selectable action in a manner that results in the initiation of the first user-selectable action in response to user interaction with the first physical control element following a reconfiguration of one from the group of firmware corresponding to the input device and a device driver corresponding to the input device that changes a control element signal generated by the first physical control element.

2. The method of claim 1, wherein automatically maintaining the relationship between the first user-selectable action and the first physical control element occurs within the application program execution context.

3. The method of claim 1, wherein the application program is a computer game.

4. The method of claim 1, wherein the application program is a massively multiplayer online (MMO) game client.

5. The method of claim 1, further comprising displaying a graphical element corresponding to the input device, the graphical element providing a visual indication of at least a first physical control element within the set of physical control elements;

6. The method of claim 5, wherein displaying a graphical element corresponding to the input device, establishing a relationship between the first physical control element and a first user-selectable action, and automatically maintaining a relationship between the first user-selectable action and the first physical control element are performed by the execution of program instructions defined by an add-on to the application program that provides functional capabilities beyond a base set of application program functional capabilities.

7. The method of claim 5, wherein establishing a relationship between the first physical control element and the first user-selectable action occurs in response to user input directed to the graphical element corresponding to the input device.

8. The method of claim 7, wherein the user input comprises a drag and drop operation involving a graphical representation of the first user-selectable action.

9. The method of claim 7, further comprising displaying a relationship management interface that includes a visual representation of the input device.

10. The method of claim 5, wherein displaying a graphical element corresponding to the input device comprises displaying a graphical interface that indicates for the first physical control element a physical position of the first physical control element relative to one from the group of a second physical control element within the set of physical control elements and an input device housing.

11. The method of claim 5, wherein displaying a graphical element corresponding to the input device comprises displaying an input device action bar that includes a set of input device action buttons.

12. The method of claim 11, wherein the input device includes a physical control element spatial organization that corresponds to a physical control element configuration carried by one from the group of a mobile telephone and a personal audio device.

13. The method of claim 12, wherein the input device action bar includes an input device action button spatial organization that corresponds to a physical control element configuration carried by one from the group of a mobile telephone and a personal audio device.

14. The method of claim 5, further comprising displaying an application program Graphical User Interface (GUI), wherein displaying the graphical element corresponding to the input device occurs within the application program GUI.

15. The method of claim 1, wherein establishing the relationship between the first physical control element and the first user-selectable action comprises storing a reference to the first physical control element and a reference to the first user-selectable action in a data structure.

16. The method of claim 15, wherein establishing the relationship between the first physical control element and the first user-selectable action further comprises storing binding information that defines an association between an initial control element signal generated in response to user interaction with the first physical control element and the first user-selectable action.

17. The method of claim 16, wherein automatically maintaining the relationship between the first physical control element and the first user-selectable action comprises updating binding information to indicate an association between the first user-selectable action and an updated control element signal generated in response to user interaction with the first physical control element.

18. The method of claim 17, wherein automatically maintaining the relationship between the first physical control element and the first user selectable action comprises determining whether an initial mapping between the first physical control element and the initial control element event signal has changed.

19. The method of claim 18, wherein determining whether the initial mapping between the first physical control element and the initial control element signal has changed is performed within the application program execution context.

20. The method of claim 18, wherein determining whether the initial mapping between the first physical control element and the initial control element signal has changed is performed by the execution of program instructions defined by an add-on to the application program.

21. The method of claim 18, wherein determining whether the initial mapping between the first physical control element and the initial control element event signal has changed comprises determining whether an updated mapping between the first control element and an updated control element event signal is indicated by one from the group of an updated firmware configuration corresponding to the input device and an updated device driver configuration corresponding to the input device.

22. A computer based method for managing at least one relationship corresponding to a set of physical control elements carried by an input device and a set of user-selectable actions performed by an application program in response to user input, comprising:
establishing an application program execution context;
retrieving first relationship information that indicates a first application program action that is intended to be initiated in response to user interaction with the first physical control element within the set of physical control elements;
retrieving configuration information that indicates a mapping between the first physical control element and a control element signal that is generated in response to user interaction with the first physical control element;
retrieving first binding information that indicates an association between the first application program action and a control element signal that can be generated by a physical control element within the set of physical control elements; and
updating the first binding information to indicate an association between the first application program action and the control element signal that is generated in response to user interaction with the first physical control element.

23. The method of claim 22, wherein updating the first binding information occurs within the application program execution context.

24. The method of claim 22, wherein each of retrieving first relationship information, retrieving configuration information, retrieving first binding information, and updating the first binding information occurs within the application program execution context.

25. The method of claim 22, further comprising determining whether a mismatch exists between the control element signal indicated by the configuration information and the control element signal indicated by the first binding information.

26. The method of claim 22, further comprising
displaying a graphical user interface (GUI) that includes a visual representation of the first physical control element and a second physical control element within the set of physical control elements;
initiating user interaction with the application program;
storing second relationship information that indicates a second application program action that is intended to be initiated in response to user interaction with the second physical control element; and
storing second binding information that indicates an association between the second application program action and a control element signal that is generated by the second physical control element in response to user interaction with the second physical control element,
wherein storing the second relationship information and storing the second binding information occur in response to user interaction with the GUI.

27. The method of claim 26, wherein user interaction with the GUI comprises a drag and drop operation that involves an icon corresponding to the second application program action.

28. The method of claim 26, further comprising:
deleting the first relationship information; and
deleting the first binding information,
wherein deleting the first relationship information and deleting the first binding information occur in response to user interaction with the GUI.

29. The method of claim 28, wherein user interaction with the GUI comprises a drag and drop operation that involves an icon corresponding to the first application program action.

30. A computer readable medium storing program instructions for:
establishing a relationship between a first physical control element within a set of physical control elements carried by an input device and a first application program action provided by an application program; and
maintaining the relationship between the first physical control element and the first application program action in a manner that results in the initiation of the application program action in response to user interaction with the first physical control element following a reconfiguration of one from the group of firmware corresponding to the input device and a device driver corresponding to the input device that changes a control element signal generated by the first physical control element.

31. The computer readable medium of claim 30, wherein the program instructions comprise an add-on.

32. The computer readable medium of claim 30, wherein the program instructions for establishing a relationship between the first physical control element and the first application program action comprise program instructions for displaying a graphical element corresponding to the input device, the graphical element providing a visual representation of at least a first physical control element within a set of physical control elements carried by the input device, the visual representation indicating a position of the first physical control element relative to one from the group of a second physical control element and an input device housing.

33. The computer readable medium of claim 30, wherein the program instructions for maintaining the relationship between the first physical control element and the first user-selectable action comprise program instructions for:
retrieving relationship information that indicates a first application program action that is intended to be initiated in response to user interaction with the first physical control element;
retrieving configuration information that indicates a mapping between the first physical control element and a control element signal that is generated in response to user interaction with the first physical control element;
retrieving binding information that indicates an association between the first application program action and a control element signal that can be generated by a physical control element within the set of physical control elements; and
updating the binding information to indicate an association between the first application program action and a control element signal that is generated by the first physical control element.

34. The computer readable medium of claim 33, further storing program instructions for determining whether a mismatch exists between the control element signal indicated by the configuration information and the control element signal indicated by the binding information.

35. A system for managing a set of relationships between a set of physical control elements carried by an input device and a set of user-selectable actions performed by an application program, the system comprising:
a processing unit;
an input device coupled to the processing unit, the input device carrying the set of physical control elements and configured to generate a control element signal in response to user interaction with at least one physical control element within the set of physical control elements; and
a memory coupled to the processing unit, the memory comprising:
an application program; and
an input device mapping module comprising a set of program instructions for graphically defining and maintaining a set of application program action—physical input device control element relationships in response to user input in a manner that retains consistency between the execution of application program actions and user interaction with physical input device control elements following one from the group of an input device firmware reconfiguration and an input device driver reconfiguration.

36. The system of claim 35, wherein the input device mapping module is executable within the execution context of the application program.

37. The system of claim 35, wherein the input device mapping module comprises an add-on to the application program.

38. The system of claim 36, wherein the application program comprises a computer game.

39. The system of claim 37, wherein the application program comprises a massively multiplayer online (MMO) game client and the input device mapping module comprises an MMO game client add-on.
